(19) United States
(12) Patent Application Publication
(10) Pub. No.: US 2011/0188756 A1
(43) Pub. Date: Aug. 4, 2011

(54) E-DICTIONARY SEARCH APPARATUS AND METHOD FOR DOCUMENT IN WHICH KOREAN CHARACTERS AND CHINESE CHARACTERS ARE MIXED

(75) Inventors: Dong-Chang LEE, Daegu (KR); Sang-Ho Kim, Suwon-si (KR); Seong-Taek Hwang, Pyeongtaek-si (KR); Ji-Hoon Kim, Seoul (KR)

(73) Assignee: Samsung Electronics Co., Ltd., Gyeonggi-do (KR)

(21) Appl. No.: 13/020,495

(22) Filed: Feb. 3, 2011

(30) Foreign Application Priority Data
Feb. 3, 2010 (KR) 10-2010-0010013

(51) Int. Cl. G06K 9/18

(52) U.S. Cl. 382/185

(57) ABSTRACT

A method for providing a correct e-dictionary search result for a document recognition result includes performing character recognition of a document in which Korean characters (Hangul) and Chinese characters are mixed and displaying a recognition result. If a character string to be searched is selected by a user from the recognition result, determining whether the selected character string corresponds to Hangul or Chinese characters, detecting a Hangul word or a Chinese word included in the selected character string, and outputting an e-dictionary search result corresponding to the detected Hangul or a Chinese word. Accordingly, the user can use an e-dictionary function without directly inputting a search word and obtain a correct e-dictionary search result for a document in which Hangul and Chinese characters are mixed.

This application claims priority under 35 U.S.C. §119(a) to an application entitled “E-Dictionary Search Apparatus and Method for Document in which Korean Characters and Chinese Characters are Mixed” filed in the Korean Intellectual Property Office on Feb. 3, 2010 and assigned Serial No. 10-2010-0010013, the contents of which are incorporated herein by reference.

### BACKGROUND OF THE INVENTION

1. Field of the Invention

The present invention relates generally to an electronic (e)-dictionary search apparatus and method, and in particular, to an e-dictionary search apparatus and method for recognizing and searching for characters including Korean characters and Chinese characters.

2. Description of the Related Art

As camera-equipped mobile communication terminals have become more widely used, users can conveniently take pictures anytime and anywhere. To increase the value of a mobile communication terminal and satisfy various needs of a user, it is necessary to provide various additional functions on the mobile communication terminal. For example, business people and students are interested in an e-dictionary function implemented in a mobile communication terminal.

This e-dictionary function is implemented through various methods, e.g., a method of directly inputting a search word by a user and a method of inputting a search word by capturing a desired word using a camera. The e-dictionary function using a camera is implemented by inputting a document image using a camera by a user, performing character recognition of the input document image, searching an e-dictionary database for recognized characters, and displaying a search result on a screen. Accordingly, the user can use the e-dictionary function without directly inputting a search word.

For general character recognition, feature-based character recognition is performed by converting a captured document image to monochrome image data, performing image pre-processing, such as binarization, separating individual characters from the binarized character image, and extracting features of the individual characters. The individual character separation occurs by extracting individual characters from a consecutive character string or consecutive words on a character by character basis and is one of processes preceding the character recognition.

Thereafter, a user selects a word to be searched from a result of the character recognition, and the selected word is linked to an e-dictionary database to output a translation result. Here, accuracy of the output translation result depends on recognized word information. As described above, in the character recognition process, accuracy of an e-dictionary translation result for a recognized result is required. Moreover, in a limited environment using an e-dictionary database equipped in a mobile communication terminal, securing accuracy of a translation result for a recognized result is most important.

### SUMMARY OF THE INVENTION

As described above, a user selects a search word on a word basis, and an e-dictionary performs a search on a word basis. Accordingly, in recognizing Korean characters, when an e-dictionary is searched for a compound noun in the form of combining a noun and a noun on a word basis, it is difficult to obtain a correct translation result. In particular, when a limited capacity e-dictionary database in a mobile communication terminal is used, the probability of not outputting a correct translation result increases. Moreover, conventional character recognition methods aim at documents composed of only Korean characters or English. Accordingly, since it is difficult to obtain a correct translation result for a document in which Korean characters and Chinese characters are mixed, applying a conventional character recognition method to the document is limited.

An aspect of the present invention is to substantially solve at least the above problems and/or disadvantages and to provide at least the advantages below. Accordingly, an aspect of the present invention is to provide an apparatus and method for increasing an e-dictionary search function by efficiently performing character separation from a document in which Korean characters and Chinese characters are mixed.

According to one aspect of the present invention, there is provided an electronic (e)-dictionary search apparatus including a character recognizer for performing character recognition of a document image, a recognition result post-processor for, if a character string to be searched is selected by a user from a result of the character recognition, determining whether the selected character string corresponds to Korean (Hangul) characters or Chinese characters, an e-dictionary search unit for searching a Hangul dictionary database for a Chinese word of the selected character string if the selected character string corresponds to Chinese characters and searching a Chinese character dictionary database for a Hangul word of the selected character string if the selected character string corresponds to Hangul, and a display unit for displaying the result of the character recognition and a search result of the e-dictionary search unit.

According to another aspect of the present invention, there is provided a method for providing an electronic (e)-dictionary search result according to character recognition in a camera-equipped e-dictionary search apparatus, the method including performing character recognition of a document image, if a character string to be searched is selected by a user from a result of the character recognition, determining whether the selected character string corresponds to Korean (Hangul) characters or Chinese characters, and performing an e-dictionary search for the selected character string in a Hangul or Chinese character dictionary database according to a result of the determination.

### BRIEF DESCRIPTION OF THE DRAWINGS

The above and other objects, features and advantages of the present invention will become more apparent from the following detailed description when taken in conjunction with the accompanying drawing in which:

FIG. 1 is a block diagram of an e-dictionary search apparatus according to an embodiment of the present invention;

FIGS. 2 and 3 are flowcharts of a process of recognizing a document in which Korean characters and Chinese characters are mixed in the e-dictionary search apparatus, according to an embodiment of the present invention;

FIG. 4 illustrates a search result of a Chinese word according to an embodiment of the present invention; and

FIG. 5 illustrates a search result of a Korean word according to an embodiment of the present invention.

### DETAILED DESCRIPTION OF EMBODIMENTS OF THE PRESENT INVENTION

Embodiments of the present invention will be described herein below with reference to the accompanying drawings. In the following description, although many specific items, such as components of a concrete circuit, are shown, they are only provided to help general understanding of the present invention, and it will be understood by those of ordinary skill in the art that the present invention can be implemented without these specific items. In the following description, well-known functions or constructions are not described in detail since they would obscure the invention with unnecessary detail.

The present invention provides a method for providing a correct e-dictionary search result for a document recognition result. In particular, the method of the present invention includes displaying a recognition result by performing character recognition of a document in which Korean characters (Hangul) and Chinese characters are mixed, if a character string to be searched is selected by a user from a result of the character recognition, determining whether the selected character string corresponds to Hangul or Chinese characters, detecting a Hangul word or Chinese word included in the selected character string, and outputting an e-dictionary search result corresponding to the detected Hangul word or Chinese word. By doing this, the user can use an e-dictionary function without directly inputting a search word and obtain a correct e-dictionary search result of a document in which Hangul and Chinese characters are mixed.

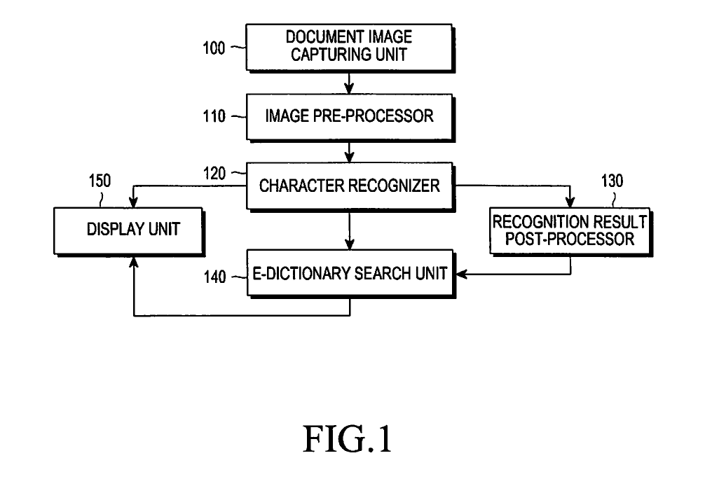

Components and operations of an e-dictionary search apparatus in which the above-described function is implemented will now be described with reference to FIG. 1. Here, the e-dictionary search apparatus corresponds to an electronic device, for example, a mobile communication terminal, an MP3 player, a Personal Media Player (PMP), a game machine, or a laptop computer.

Referring to FIG. 1, the e-dictionary search apparatus includes a document image capturing unit 100, an image pre-processor 110, a character recognizer 120, a recognition result post-processor 130, an e-dictionary search unit 140, and a display unit 150.

The document image capturing unit 100 is a means of capturing a document image and corresponds to a camera. The document image capturing unit 100 delivers image data of a captured document to the image pre-processor 110.

The image pre-processor 110 converts the image data to monochrome image data and performs processing, such as binarization, of the monochrome image data.

The character recognizer 120 performs character recognition of the image data delivered from the image pre-processor 110 to convert the image data to text data. The character recognizer 120 performs character recognition by separating individual characters from the text data and matching the individual characters to a feature database pre-installed according to feature patterns. The recognized characters are temporarily stored in the structure of line-word-character that is a basic structure of a recognition result.

After completing the character recognition, the display unit 150 displays the recognition result on a screen. A user can select a desired word from the recognition result displayed on the display unit 150.

The e-dictionary search unit 140 searches an e-dictionary database for the selected word and outputs a search result of the selected word. Here, the e-dictionary search apparatus according to the present invention further includes the recognition result post-processor 130 to perform a post-processing process of the recognition result before the search in order to provide a more correct e-dictionary search result.

In particular, in the case of a document image in which Hangul and Chinese characters are mixed, the recognition result post-processor 130 determines whether the word selected by the user is a Hangul word or a Chinese word. A post-processed recognition result including a result of the determination is provided to the e-dictionary search unit 140.

In the case of a Chinese word, the e-dictionary search unit 140 searches a Hangul dictionary database and outputs a search result of the Chinese word through the display unit 150. In this case, individual Chinese characters composing the Chinese word also have unique meaning. Thus, it is preferable that a dictionary search function for the individual Chinese characters of the Chinese word be provided. To do this, if a piece of the individual Chinese characters of the Chinese word is selected by the user, the e-dictionary search unit 140 searches the Hangul database for the selected Chinese character and outputs a search result of the selected Chinese character through the display unit 150. The Hangul dictionary database includes a collection of words (or characters) in Chinese with their equivalents and meanings (or definitions) in Korean. The Hangul dictionary database may further include usage information, pronunciations, and other information.

In the case of a Hangul word, the e-dictionary search unit 140 searches a Chinese character database and outputs a search result of the Hangul word through the display unit 150. In particular, in the present invention, in order to provide an enhanced e-dictionary search result for a compound noun, if there is no search result for a selected Hangul word, the e-dictionary search unit 140 reconstructs a search word for the selected Hangul word by dividing the compound noun. The Chinese character dictionary database includes a collection of words (or characters) in Korean with their equivalents in Chinese and their meanings in Korean. The Chinese character dictionary database may further include usage information, pronunciations, and other information.

A process of processing a compound noun according to embodiment of the present invention is described below. In order to describe the process of processing a compound noun in detail, a case where a word [symbol] is selected is described as an example. Here, a compound word denotes a word made by combining two or more words, and this is identified as a compound noun in the current embodiment.

In the first step, the e-dictionary search unit 140 determines whether a word made by adding one character exists in the e-dictionary database while adding one character from the first character of the selected word on a character by character basis as shown in Table 1. Thereafter, the e-dictionary search unit 140 outputs the longest word among words existing in the e-dictionary database as a search result of the selected word. Accordingly, a search result of [symbol] is output.

TABLE 1

| Word combination | Existing/non-existing in e-dictionary |
|---|---|
| [symbol] | ◯ |
| [symbol] | ◯ |
| [symbol] | X |
| [symbol] | X |
| [symbol] | X |
| [symbol] | X |

Thereafter, the e-dictionary search unit 140 determines whether a word made by adding one character exists in the e-dictionary database while adding one character from the first character of a character string remaining by excluding the output word on a character by character basis. Accordingly, since a character string [symbol] remains after outputting the search result of [symbol] from the selected word [symbol] a sequential search of the character string [symbol] is performed. As a result, a search result of [symbol] is output.

TABLE 2

| Word combination | Existing/non-existing in e-dictionary |
|---|---|
| [symbol] | ◯ |
| [symbol] | ◯ |
| [symbol] | X |
| [symbol] | X |

The e-dictionary search unit 140 repeats the same method as described above for the remaining character string as shown in Table 3, and the last character of the remaining character string has a very high possibility of a postposition. Thus, the e-dictionary search unit 140 determines whether the remaining character string includes a postposition.

TABLE 3

| Word combination | Existing/non-existing in e-dictionary |
|---|---|
| [symbol] | ◯ |
| [symbol] | ◯ |
| [symbol] | X |

In Table 3, the e-dictionary search unit 140 determines whether the last character [symbol] exists in a postposition and word-ending list. If the last character [symbol] exists in the postposition and word-ending list as a result of the determination, an e-dictionary search of a character string remaining by excluding the last character is performed. As described above, since a lexical semantic search result cannot be expected for a character such as [symbol] , it is acceptable to exclude the character [symbol] from the e-dictionary search by considering the character [symbol] as a postposition. As a result, a search result of “ [symbol] ” is output.

As described above, the e-dictionary search unit 140 selects the longest character string existing in the e-dictionary database from the selected character string as a first search word through a search and displays a search result of the first search word. Thereafter, the e-dictionary search unit 140 determines whether the last character of a character string remaining is a postposition by excluding the first search word from the selected character string, and if the last character is a postposition, the e-dictionary search unit 140 removes the last character from the remaining character string, selects a second search word from the character string from which the last character has been removed, and outputs a search result of the second search word. Next, the e-dictionary search unit 140 performs an e-dictionary search function for a compound word through a repetitive search word selection method, such as selecting a third search word from a character string remaining by excluding the second search word.

In the case of a Chinese word, a search result of the e-dictionary search unit 140 is output as a Hangul word corresponding to the Chinese word through the display unit 150, and in the case of searching for a single Chinese character of the Chinese word, the meaning of the single Chinese character is output as a Hangul word through the display unit 150. Meanwhile, in the case of a Hangul word, a search result of the e-dictionary search unit 140 is output as a Chinese word corresponding to the Hangul word through the display unit 150, and in the case of a compound noun, the meaning of a reconstructed search word is output as a Chinese word through the display unit 150.

The display unit 150 displays an intermediate processing result of a document image, a character recognition result, and an e-dictionary search result to the user.

By using the post-processed recognition result as described above, the e-dictionary search unit 140 performs an e-dictionary search and outputs a search result through the display unit 150. By doing this, the user can see a search result of a designated search word without directly inputting a search word only if the user designates the search word through a method, such as clicking, on a document image in which Hangul and Chinese characters are mixed.

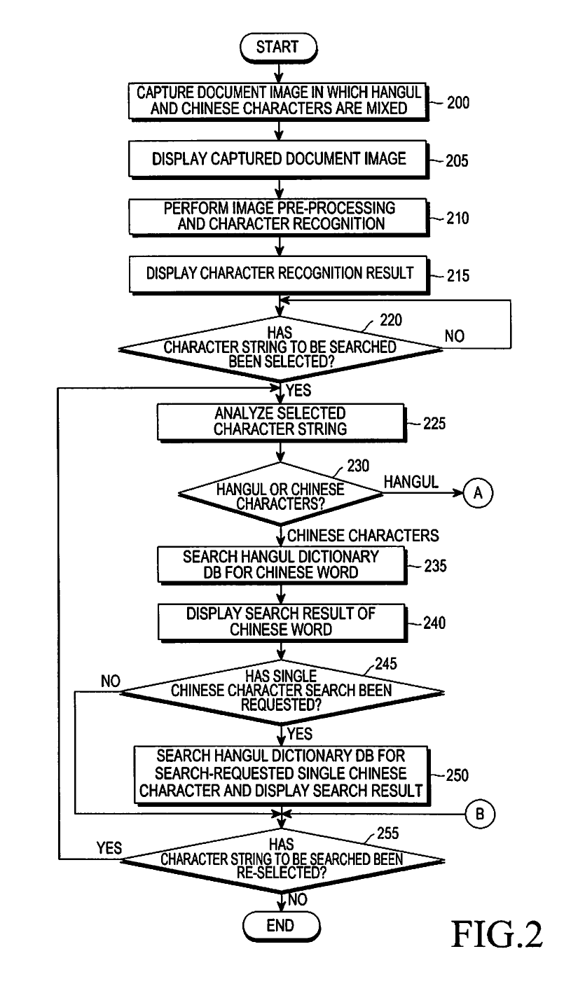

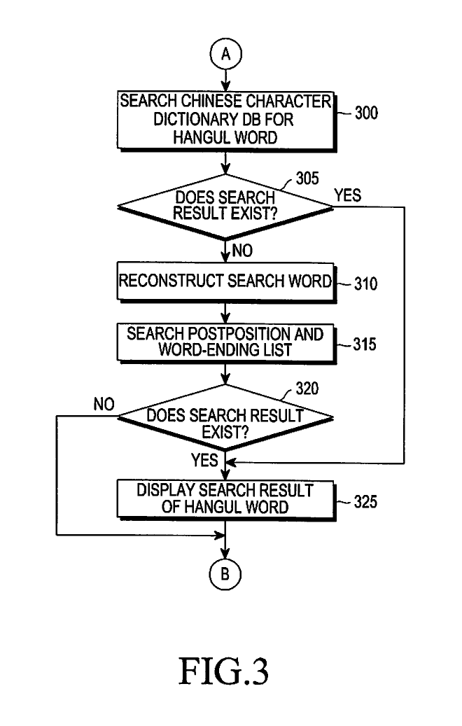

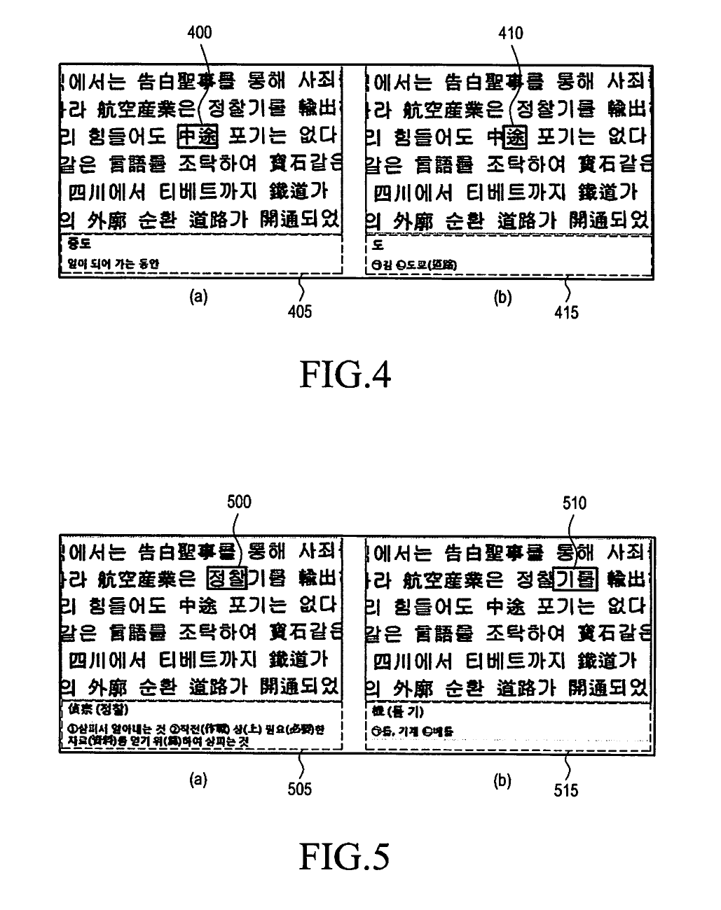

An operation of the e-dictionary search apparatus having the above-described configuration will now be described with reference to FIGS. 2 and 3. Here, a user can capture a document to be recognized by driving a camera equipped in the e-dictionary search apparatus, and in the following description, a case where a document in which Hangul and Chinese characters are mixed is captured will be illustrated as shown in FIGS. 4 and 5.

Referring to FIG. 2, if a document image in which Hangul and Chinese characters are mixed is captured in step 200, the e-dictionary search apparatus displays the captured document image on a screen in step 205. In addition, the captured document image is stored in a memory. Thereafter, the e-dictionary search apparatus performs an operation of processing the stored document image to be suitable for recognition. Accordingly, the e-dictionary search apparatus performs image pre-processing and character recognition in step 210. Since the captured document image is a color image, the color image is converted to a gray image and binarized, and individual characters in the pre-processed image are separated, and the character recognition is performed based on features of the separated individual characters.

If the character recognition is completed, a result of the character recognition is displayed on the screen in step 215. The user can select a character string to be searched for from the screen on which the result of the character recognition is displayed. Accordingly, the e-dictionary search apparatus determines in step 220 whether a character string to be searched for has been selected, and if a character string has been selected according to a result of the determination, the e-dictionary search apparatus analyzes the selected character string in step 225. In this case, the character string selected by the user is selected on a word basis. Alternatively, the selected character string may be selected based on word spacing.

As shown in FIGS. 4 and 5, since Hangul and Chinese characters are mixed in the document image captured by the user, a process of determining whether the selected character string corresponds to Hangul or Chinese characters must be performed in advance. To do this, after analyzing the selected character string in step 225, the e-dictionary search apparatus determines in step 230 whether the selected character string corresponds to Hangul or Chinese characters. If the selected character string corresponds to Hangul as a result of the determination, the e-dictionary search apparatus proceeds to step 300 of FIG. 3, wherein symbol A is used to indicate step 230 of FIG. 2 is linked to step 300 of FIG. 3. In addition, symbol B is used to indicate step 325 of FIG. 3 is linked to step 225 of FIG. 2.

If the character string selected by the user corresponds to Chinese characters, the e-dictionary search apparatus searches a Hangul dictionary Database (DB) for a Chinese word corresponding to the selected character string in step 235. That is, in the case of a Chinese word, the Hangul dictionary database is used to display Hangul characters corresponding to the Chinese word. According to the search, the e-dictionary search apparatus displays a search result of the Chinese word in step 240.

FIG. 4(a) illustrates a recognition result of the captured document image, wherein a search result of the case where the user selects a Chinese word is shown. As shown in FIG. 4(a), when the user selects a character string [symbol] 400 from the recognized characters, an e-dictionary search result of the selected character string is displayed in a result window 405. That is, in the result window 405, the pronunciation [symbol] and the meaning [symbol] (while things are going)’ of the Chinese characters are displayed.

In the case of Chinese characters, when the search result is displayed on the screen, although a word-based search is important, and since individual Chinese characters composing a word have their unique meaning, an e-dictionary search function for a single character of a recognized Chinese word must be provided. Accordingly, the e-dictionary search apparatus determines in step 245 whether the user has requested a search of a single Chinese character. If the user has requested a search of a single Chinese character as a result of the determination, the e-dictionary search apparatus searches the Hangul dictionary database for the search-requested single Chinese character in step 250 and displays a search result.

FIG. 4(b) illustrates a search request result of a single Chinese character 410 of the selected character string 400. As shown in FIG. 4(b), if the user selects the single Chinese character [symbol] 410 after selecting the character string [symbol] 400, the pronunciation [symbol] and the meaning [symbol] (road)’ of the Chinese character are displayed in a search window 415.

If the character string selected by the user corresponds to Hangul in step 230, the e-dictionary search apparatus searches a Chinese character dictionary Database (DB) for a Hangul word corresponding to the selected character string to display a Chinese word in step 300. If a search result exists in step 305, the e-dictionary search apparatus proceeds to step 325 to display the search result of the Hangul word. If a search result does not exist in step 305, the e-dictionary search apparatus proceeds to step 310 to reconstruct a search word for the selected character string.

In general, word-based data registered in an e-dictionary database equipped in a terminal is composed of individual words except for proper nouns. For example, in the case of compound nouns composed of two words, such as [symbol] and [symbol] a correct search result cannot be provided from an e-dictionary. Thus, it is needed to divide a compound noun before an e-dictionary search of the compound noun. Accordingly, in an embodiment of the present invention, a correct search result is provided using a method of reconstructing a search word. As a search word reconstruction method, a method of increasing the number of characters by 1 from the beginning of the selected character string while determining whether the character(s) exist(s) in the e-dictionary database is used.

FIG. 5(a) illustrates a recognition result of the captured document image, wherein when the user selects a Hangul word, Chinese characters and the meaning corresponding to the Hangul word are displayed as a search result. If the character string selected by the user corresponds to a Hangul word [symbol] the e-dictionary search apparatus determines whether an e-dictionary search result of the first character [symbol] of the Hangul word exists. After repeatedly performing the e-dictionary search by increasing the number of characters by 1, the e-dictionary search apparatus separates the longest word existing in the e-dictionary database as a single search word from the selected character string as a result of the e-dictionary search. Thereafter, for the remaining character string, the search process is repeatedly performed.

Thus, even though the user selects the character string [symbol] if only the meaning of [symbol] is stored in the e-dictionary database, Chinese characters and the meaning of [symbol] 500 are displayed in a search window 505 as shown on FIG. 5(a).

In FIG. 5(a), the Hangul word [symbol] is separated from the selected character string [symbol] and a search result of the Hangul word [symbol] is displayed. In this case, a character string [symbol] remains. Then, the e-dictionary search apparatus searches a postposition and word-ending list in step 315 of FIG. 3 to determine whether the last character of the remaining character string corresponds to a postposition. If a character corresponding to the last character exists in the postposition and word-ending list as a result of the determination, the e-dictionary search apparatus determines the last character as a postposition and removes the last character from the remaining character string. That is, only “ [symbol] ” remains from [symbol] Thereafter, the e-dictionary search apparatus searches the Chinese character dictionary database for the remaining character string, i.e., a Hangul word, and determines in step 320 whether a search result exists. If a search result exists as a result of the determination, the e-dictionary search apparatus displays the search result of the Hangul word in step 325. Thereafter, the e-dictionary search apparatus proceeds to step 255 of FIG. 2 to determine whether a search character string is reselected by the user, and if a search character string is reselected, the e-dictionary search apparatus proceeds back to step 225 to repeat the above-described process.

FIG. 5(b) illustrates a search result of a Hangul word [symbol] 510 remaining by separating the word [symbol] from the selected character string [symbol] As shown in FIG. 5(b), since [symbol] is considered as a postposition and removed from [symbol] only the meaning of [symbol] is displayed as a Hangul dictionary search result in a search window 515.

As described above, the present invention recognizes Hangul and Chinese characters at the same time, processes a character string in correspondence with features of the recognized Hangul or Chinese characters, and performs an e-dictionary search based on the character string processing result.

According to the present invention, in character recognition and an e-dictionary-linked information search of a document in which Hangul and Chinese characters are mixed, e-dictionary information is simultaneously searched for and Hangul and Chinese characters are recognized together, thereby increasing an e-dictionary search function. In addition, the present invention implements an e-dictionary database in a mobile communication terminal, thereby providing an e-dictionary search result for a document in which Hangul and Chinese characters are mixed even in a limited resource environment. The present invention also performs an e-dictionary search by using a post-processing method suitable for grammatical characteristics of corresponding characters for a recognized character string selected by a user, providing more correct e-dictionary search result information.

While the invention has been shown and described with reference to a certain embodiment thereof, it will be understood by those skilled in the art that various changes in form and details may be made therein without departing from the spirit and scope of the invention as defined by the appended claims.

What is claimed is:

1. An electronic (e)-dictionary search apparatus for a document in which Korean (Hangul) characters and Chinese characters are mixed, comprising:
a character recognizer for performing character recognition of a document image;
a recognition result post-processor for, if a character string to be searched is selected by a user from a result of the character recognition, determining whether the selected character string corresponds to Hangul or Chinese characters;
an e-dictionary search unit for searching a Hangul dictionary database for a Chinese word of the selected character string if the selected character string corresponds to Chinese characters and searching a Chinese character dictionary database for a Hangul word of the selected character string if the selected character string corresponds to Hangul; and
a display unit for displaying the result of the character recognition and a search result of the e-dictionary search unit.

2. The e-dictionary search apparatus of claim 1, further comprising:
a document image capturing unit for capturing a document image in which Hangul and Chinese characters are mixed; and
an image pre-processor for converting the captured document image to a binarized monochrome image and delivering the binarized document image to the character recognizer.

3. The e-dictionary search apparatus of claim 1, wherein the e-dictionary search unit displays pronunciation and meaning of the Chinese word with the Hangul word on the display unit after searching the Hangul dictionary database for the Chinese word of the selected character string.

4. The e-dictionary search apparatus of claim 3, wherein the e-dictionary search unit determines whether a single Chinese character search of the Chinese word of the selected character string has been requested, and if the single Chinese character search has been requested, the e-dictionary search unit searches the Hangul dictionary database for the search-requested single Chinese character and displays the pronunciation and meaning of the single Chinese character with the Hangul character on the display unit.

5. The e-dictionary search apparatus of claim 1, wherein the e-dictionary search unit displays Chinese characters and the meaning corresponding to the Hangul word on the display unit after searching the Chinese character dictionary database for the Hangul word of the selected character string.

6. The e-dictionary search apparatus of claim 1, wherein, if the Hangul word of the selected character string is not found in the Chinese character dictionary database, the e-dictionary search unit searches the Chinese character dictionary database for the selected character string while sequentially increasing the number of characters by 1 from the first character of the selected character string.

7. The e-dictionary search apparatus of claim 6, wherein the e-dictionary search unit selects a longest character string existing in the Chinese character dictionary database from the selected character string as a first search word through the search and outputs a search result of the first search word.

8. The e-dictionary search apparatus of claim 7, wherein the e-dictionary search unit determines whether a last character of a character string remaining by excluding the first search word from the selected character string is a postposition, and if the last character is a postposition, the e-dictionary search unit removes the last character from the remaining character string, selects a second search word from the character string from which the last character has been removed, and outputs a search result of the second search word.

9. A method for providing an electronic (e)-dictionary search result according to character recognition in a camera-equipped e-dictionary search apparatus, the method comprising:
performing character recognition of a document image;
if a character string to be searched is selected by a user from a result of the character recognition, determining whether the selected character string corresponds to Korean (Hangul) characters or Chinese characters; and
performing an e-dictionary search for the selected character string in a Hangul or Chinese character dictionary database according to a result of the determination.

10. The method of claim 9, further comprising:
capturing a document image in which Hangul and Chinese characters are mixed;
converting the captured document image to a binarized monochrome image; and
delivering the binarized document image for the character recognition.

11. The method of claim 9, wherein performing the e-dictionary search comprises:
if the selected character string corresponds to Chinese characters, searching the Hangul dictionary database for a Chinese word of the selected character string; and
displaying pronunciation and meaning of the Chinese word with a Hangul word.

12. The method of claim 11, further comprising:
determining whether a single Chinese character search of the Chinese word of the selected character string has been requested;
if the single Chinese character search has been requested, searching the Hangul dictionary database for the search-requested single Chinese character; and
displaying the pronunciation and meaning of the single Chinese character with the Hangul character.

13. The method of claim 9, wherein performing an e-dictionary search comprises:
if the selected character string corresponds to the Hangul characters, searching the Chinese character dictionary database for the Hangul word of the selected character string; and
displaying Chinese characters and the meaning corresponding to the Hangul word.

14. The method of claim 13, further comprising,
if the Hangul word of the selected character string is not found in the Chinese character dictionary database, searching the Chinese character dictionary database for the selected character string while sequentially increasing the number of characters by 1 from a first character of the selected character string.

15. The method of claim 14, further comprising:
selecting a longest character string existing in the Chinese character dictionary database from the selected character string as a first search word through the search; and
outputting a search result of the first search word.

16. The method of claim 15, further comprising:
determining whether a last character of a character string remaining by excluding the first search word from the selected character string is a postposition;
if the last character is a postposition, removing the last character from the remaining character string; and
selecting a second search word from the character string from which the last character has been removed and outputting a search result of the second search word.
